(19) United States
(12) Patent Application Publication
(10) Pub. No.: US 2022/0400536 A1
(43) Pub. Date: Dec. 15, 2022

(54) System and Method for Electric Heating Trace System Management

(71) Applicant: nVent Services GmbH, Schaffhausen (CH)

(72) Inventors: Mike Allenspach, Sugar Land, TX (US); David Parman, San Ramon, CA (US)

(21) Appl. No.: 17/839,319

(22) Filed: Jun. 13, 2022

Related U.S. Application Data
(60) Provisional application No. 63/209,648, filed on Jun. 11, 2021.

(51) Int. Cl. H05B 1/02; F16L 53/38

(52) U.S. Cl. CPC H05B 1/0244; F16L 53/38

(57) ABSTRACT

A control system for use with a pipeline that transports a process fluid. The control system includes a distributed temperature sensing system that records temperature data at a plurality of segments along a pipeline, a heating system that heats the process fluid, and a management system. The management system includes a controller that receives the temperature data from the distributed temperature sensing system and determines a first alarm condition for each segment of the plurality of segments along the pipeline. When the first alarm condition is present in adjacent segments, the controller merges the first alarm condition to create an extended segment first alarm condition encompassing the adjacent segments and displays, via a graphical user interface, a representation of the extended segment first alarm condition.

### RELATED APPLICATIONS

This application claims priority under 35 U.S.C. § 119 to U.S. Provisional Patent Application No. 63/209,648 filed on Jun. 11, 2021, the entire contents of which is incorporated herein by reference.

### BACKGROUND

The invention relates to pipeline monitoring and management systems, and particularly to systems for controlling a pipeline heating system to maintain a desired temperature and/or to provide flow assurance of process fluid along the pipeline.

Pipeline systems are often used to transport a liquid, such as Sulphur, over large distances, such as from an extraction point to a processing facility. If the extraction location and/or the processing facility are located in a cold weather environment, or even a warm weather environment, it may be necessary to provide a heating element, or heat trace, to maintain the pipe at a desired temperature to prevent the fluid product from freezing or, in temperature sensitive operations, to maintain a temperature that allows for an efficient flow of the fluid product. The heating element along with any associated components can be known as an electric heating trace (EHT) circuit.

Currently, typical EHT circuits are energized to keep the fluid in the pipe from freezing. For example, if the fluid cools, the cooler temperature may result in the transported fluid freezing, becoming more viscous and/or the fluid not being able to flow properly. The increased viscosity or phase change may cause an unwanted pressure buildup in the pipeline system.

The management of liquid pipelines generally relies on highly manual and operator-dependent approaches, with limited or no real-time data used to drive decisions. Yet failing to utilize safe, reliable and repeatable re-melting methods of solidified process fluid in the pipeline could result in a plant shutdown due to a pipeline rupture or damage from excessive movement of solidified process fluid and/or pipe anchor failures.

It may therefore be desirable to provide improved pipeline re-melt systems and processes.

### SUMMARY

Embodiments of the invention provide a control system for use with a pipeline that transports a process fluid. The control system includes a distributed temperature sensing system, a heating system, and a management system. The distributed temperature sensing system records temperature data at a plurality of segments along the pipeline. The heating system heats the process fluid in the pipeline. The management system includes a controller in electronic communication with the distributed temperature sensing system and the heating system. The controller includes a processor and memory storing specific computer-executable instructions that, when executed by the processor, cause the controller to receive the temperature data from the distributed temperature sensing system and determine a first alarm condition for each segment of the plurality of segments along the pipeline. When the first alarm condition is present in adjacent segments, the controller merges the first alarm condition to create an extended segment first alarm condition encompassing the adjacent segments and displays, via a graphical user interface, a representation of the extended segment first alarm condition.

Some embodiments of the invention provide a control system for use with a pipeline that transports a process fluid. The control system includes a distributed temperature sensing system, a heating system, and a management system. The distributed temperature sensing system records temperature data at a plurality of segments along the pipeline, wherein the plurality of segments make up a total length of the pipeline. The heating system heats the process fluid in the pipeline. The management system includes a controller in electronic communication with the distributed temperature sensing system and the heating system. The controller includes a processor and memory storing specific computer-executable instructions that, when executed by the processor, cause the controller to receive the temperature data from the distributed temperature sensing system and determine a first condition for each segment of the plurality of segments along the pipeline. The controller further calculates a risk score of the pipeline based on the first alarm condition and displays, via a graphical user interface, a representation of the risk score.

Embodiments of the invention provide a control system for use with a pipeline that transports a process fluid. The control system includes a distributed temperature sensing system, a heating system, and a management system. The distributed temperature sensing system records temperature data at a plurality of segments along the pipeline. The heating system heats the process fluid in the pipeline. The management system includes a controller in electronic communication with the distributed temperature sensing system and the heating system. The controller includes a processor and memory storing specific computer-executable instructions that, when executed by the processor, cause the controller to receive the temperature data from the distributed temperature sensing system and map the plurality of segments to a virtual model of the pipeline by coordinating temperature data associated with ends of the distributed temperature sensing system to ends of the pipeline. The controller further determines a condition of each segment of the plurality of segments along the pipeline and displays, via a graphical user interface, the condition on the virtual model of the pipeline.

### DESCRIPTION OF THE DRAWINGS

FIG. 1 is a schematic diagram of an electric heat trace (EHT) control system according to some embodiments.

FIG. 2 is a schematic diagram of another control system according to some embodiments.

FIG. 3 is a diagram of hardware for implementing a temperature sensing system and a management system of a control system.

FIG. 4 is schematic diagram of another control system, according to some embodiments, including a skin effect heating system.

FIG. 5 is a flowchart of a process for monitoring a pipeline according to some embodiments.

FIG. 6 is a flowchart of a process for monitoring flow states within a pipeline using distributed temperature sensing (DTS) data, according to some embodiments.

FIG. 7 is a diagram of a graphical user interface (GUI) displace for use with pipeline monitoring.

FIG. 8 is another diagram of a GUI display for use with pipeline monitoring.

FIG. 9 is a flowchart of a process for mapping a pipeline model to a physical pipeline structure.

FIG. 10 is a flowchart of a process for calculating a risk score of a pipeline.

FIG. 11 is a flowchart of a process for aggregating alarms in a pipeline management system.

FIG. 12 is a flowchart of a process for generating a shift report in a pipeline management system.

FIG. 13 is a flowchart of a process for re-melt assistance of a process fluid in a pipeline.

FIGS. 14A and 14B illustrate a flowchart of heating system temperature setpoint control for a pipeline.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Managing the temperature of a process fluid (e.g., oil, natural gas, molten materials) during transportation through a pipeline can be of key concern, particularly when the process fluid is a material that exhibits changing viscosity characteristics relative to temperature. For example, the physical properties of Sulphur and its narrow operating temperature zone create many design challenges in a Sulphur pipeline. More specifically, in a Sulphur pipeline, the fluid will experience three different flow regimes during its operational life: (1) flowing, i.e., moving or molten, Sulphur (temperature above freezing); (2) stagnant, i.e., liquid, Sulphur not flowing, but still in a molten state; and (3) plugged, in which portions of the pipeline have experienced Sulphur solidification, perhaps with formation of voids, which forms one or more plugs within the pipeline. A critical issue in the performance and operational life of a Sulphur pipeline is the safe and reliable re-melt of solidified Sulphur to re-establish flow.

Most attention has historically been placed on assuring that the required pipeline maintenance temperature is achieved during normal operations. However, first, localized thermal discontinuities, from a heat transfer perspective, create a complex and dynamic environment such that discrete temperature monitoring, on its own, may be insufficient for optimal pipeline maintenance. More specifically, while a 100% uniform thermal profile (i.e., with respect to the temperature of the process fluid) along the entire constructed pipeline is ideal, it is oftentimes not realistic due to discontinuities such as, but not limited to, pipeline void spaces (liquid-free zones), excessive heat loss zones (such as pipe supports/anchors) and the impact of elevational changes (peaks/valleys and/or vertical risers). For example, a section of the pipeline having a low elevation level and having comparatively high elevation adjacent pipeline sections ahead and behind will be likely to accumulate solidified process material due to its geometry. Considering the case of Sulphur, when Sulphur transitions from a liquid to a solid, the volume of the Sulphur decreases. When Sulphur in the low elevation section of the pipeline solidifies, the amount of volume taken up by this Sulphur decreases, allowing liquid Sulphur to flow from adjacent sections of pipe into gaps created by this decrease in volume. In this way, it is possible for a section of pipeline to become completely filled (e.g., plugged) with solid Sulphur.

Second, because the re-melting of Sulphur (i.e., from solid to liquid) in the pipeline can occur at different rates in various portions of the line, re-melt must be performed in a manner that does not overpressure the pipe or allow other pipeline failure modes to occur. For example, re-establishing flow in a plugged pipeline is a difficult endeavor because the solid-to-liquid phase change of Sulphur creates expansive forces from the volume increase that occurs when solid Sulphur melts and becomes liquid Sulphur. These expansive forces may over-pressurize the pipeline if not accounted for correctly, thereby potentially damaging the pipeline. If sufficient pressure is placed behind a plug of solidified Sulphur in a pipeline, the plug could break loose as a result of the pressure and move, uncontrolled, through the pipeline, potentially damaging the pipeline in the process (e.g., by forcefully coming into contact with sidewalls of the pipeline).

Historically, the management of liquid Sulphur pipelines has been left largely to a shift operator who uses judgement and experience to make appropriate decisions. This is a highly manual and operator-dependent approach, with limited or no real-time data used to drive decisions. It becomes, many times, a “best guess” manual approach to managing the pipeline, which can lead to failures due to human error. Poor or inexperienced planning may result in a non-homogenous thermal profile for the pipeline, with solidification of process fluid occurring at unknown locations.

Furthermore, pipeline failures may be caused by pressure build-up in a pipeline due to, for example: lack of pressure management; welded pipe shoes or faulty anchor design, causing areas of high heat loss; insufficient thickness and/or poor field installation of thermal insulation; inability to monitor pipeline temperature along the entire length of the pipeline; absence of any extra heat delivery capability during “emergency conditions” when localized heat losses create cold zones along the pipeline; excessive pipeline movements; “runaway heating” at voids/empty zones present in the pipeline from process fluid solidification; and/or absence of a clear and methodical re-melt procedure. The dynamics of these issues require a multi-disciplinary approach and in-depth experience with process fluid properties and pipeline operational behavior in order for these issues to be properly addressed.

The foregoing needs are met by the methods, apparatus, and/or systems herein for monitoring and managing a pipeline in order to maintain desired characteristics, such as temperature, of a process fluid in the pipeline. In some embodiments, a control system for a pipeline may include: one or more trace heating cables, such as skin-effect heat tubes, to provide heat to the pipeline (e.g., as part of a heating system); a fiber optic cable for distributed temperature sensing along the pipeline; optionally, a plurality of sensors for detecting and reporting pipeline operating data; pre-insulated pipe; thermally isolated pipe supports and anchors; and a monitoring and re-melt program implemented through a computerized management system.

The combined instrumentation along the pipeline may be used to gather key decision-making data, and programs of some embodiments operate on such data to determine whether to change operating parameters of the heating system, generate alarms in response to changes in sensed parameters, and/or generate reports and/or alerts to guide manual operations. For example, to combat thermal discontinuities, an accurate mapping of the rate of temperature change, along with other operational parameters, may yield a more sophisticated and predictable real-time model for process fluid re-melt. The development of specialized algorithms based on trends in measured or otherwise obtained data during commissioning, preliminary start-up, and/or operation could provide the early indication of potential failure modes and can serve to more precisely monitor and assess dynamic pipeline conditions, attributing to the successful implementation of a customized automated re-melt program. For example, by monitoring temperature trends along the pipeline, it is possible to predict and track the movement of freely-moving plugs in the pipeline. Accordingly, some embodiments can use predictive modeling, transient analysis, and improved software solutions to create a dynamic, real-time model for detecting and/or predicting solidification of Sulphur (or other process fluids) as it undergoes phase changes inside the pipeline.

While the present disclosure is presented with particular details relevant to the monitoring of liquid Sulphur and re-melting of solidified Sulphur in a Sulphur pipeline, it should be noted that the details described herein may also apply to other pipelines and other process fluids, including petroleum, various types of crude or processed oil, natural and highly volatile gasses, chemicals, and the like. The descriptions herein therefore are not limited in application to Sulphur pipelines.

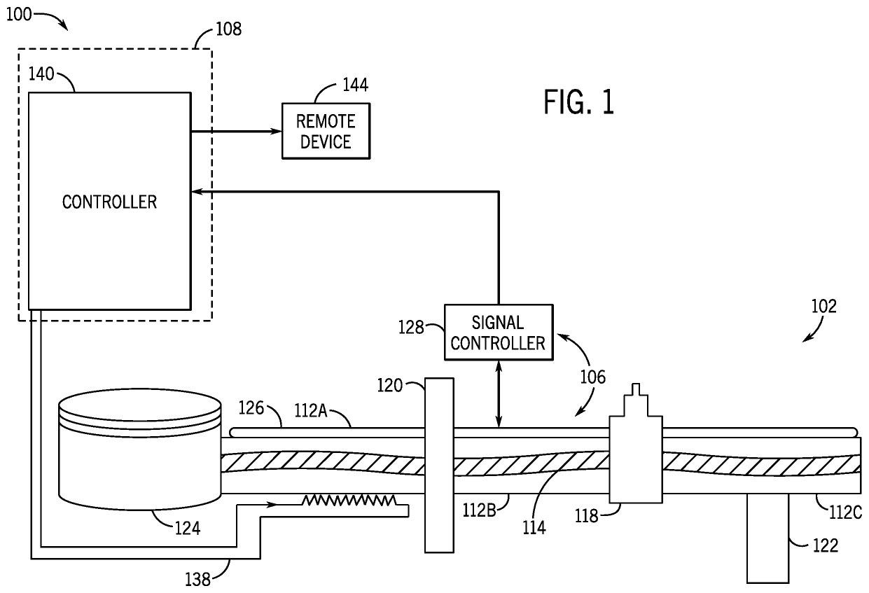

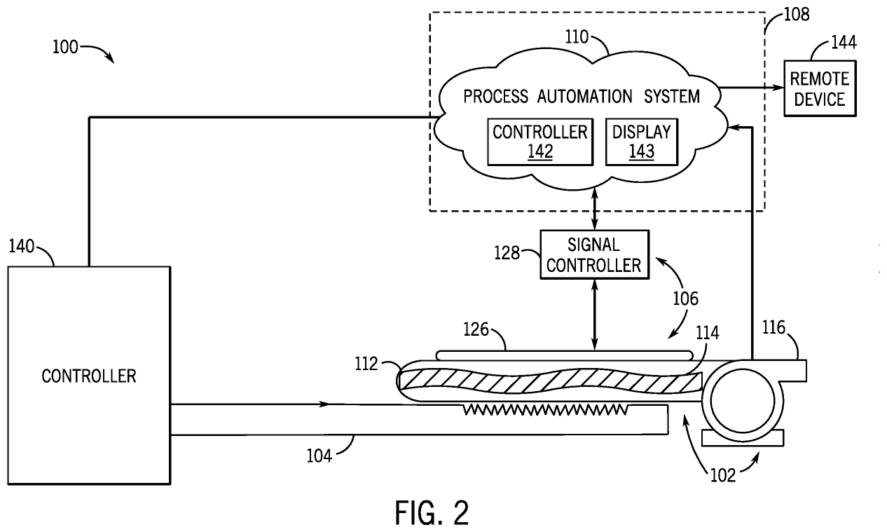

In light of the above, FIG. 1 illustrates a control system 100 according to some embodiments of the invention. The control system 100 may also be referred to as a heating system, an electric heat trace (EHT) system, a pipeline management system, and/or a pipeline temperature management system. The control system 100 can be used with a pipeline system 102 (e.g., a “fluid transport system” or “pipeline network”) and can include at least a heating system 104 (e.g., a heating circuit), a temperature sensing system 106, and a management system 108. FIG. 2 illustrates another control system 100, according to some embodiments, including all of the components of FIG. 1, as well as a process automation system 110. While certain components may be described below with reference to the system 100 of FIG. 1 or FIG. 2, it should be noted that such components may be incorporated into either system 100 of FIG. 1 or FIG. 2, even if not specifically described in that manner.

With reference to the pipeline system 102, in some embodiments, the pipeline system 102 can include one or more pipes 112 and can transport a fluid 114 such as, but not limited to, Sulphur. For example, as shown in FIG. 1, the pipes 112 can include a first pipe 112A, a second pipe 112B, and a third pipe 112C coupled together. In some embodiments, as shown in FIG. 2, the pipeline system 102 can also include a pump 116 and a pump motor (not shown) configured to pump the fluid 114 throughout the pipes 112. However, some applications may not require a pump for fluid flow, such as gravity-fed applications.

Additionally, in some embodiments, the pipeline system 102 can include one or more storage or transportation devices, fittings, and/or support structures. Storage or transportation devices may be devices other than pipes that are capable of storing and/or transporting fluids such as, but not limited to, tanks and/or storage vessels. Fittings may include, but are not limited to, adaptors, elbows, couplings, unions, nipples, reducers, tees, crosses, end caps, electrical or mechanical valves, flanges, and/or other devices interconnected with pipes 112 and storage or transportation devices. Support structures may include, but are not limited to, pipe anchors and/or pipe guides configured to hold the pipes 112 in place and/or prevent rotation of the pipes 112.

As an example, as shown in FIG. 1, the pipeline system 102 can include a valve 118, a flange 120, a pipe anchor 122, and a holding tank 124. The valve 118 can be coupled to the second pipe 112B and the third pipe 112C. The flange 120 can be coupled to the first pipe 112A and the second pipe 112B. The pipe anchor 122 can be coupled to the third pipe 112C, configured to hold the third pipe 112C in place. The holding tank 124 can be coupled to an end of the first pipe 112A.

Ideally, the pipeline system 102 has a “uniform thermal profile” in which there are no heat sinks along the pipeline system 102 that would cause excessive amounts of heat to be lost to surrounding areas. However, in reality, the fluid 114 may exhibit different temperatures along different locations within the pipeline system 102 due to heat sinks and other non-uniform heat loss. For example, certain components of the pipeline system 102 such as, but not limited to, valves, flanges, pipe anchors, and/or pipe guides may be more susceptible to heat loss and, thus, may be referred to as “high heat loss points,” such that fluid 114 may have a lower temperature adjacent these high heat loss points. In addition, poorly installed thermal insulation around the pipes 112 can jeopardize pipeline heat loss uniformity. For example, improperly installed insulation may be exposed to moisture, and wet insulation may result in excessive heat loss at such locations.

Accordingly, it may be desirable to monitor fluid temperatures at or along a pipe 112 near one or more high heat loss points and/or on the high heat loss points, where the fluid 114 may be more prone to freezing or dropping below a temperature setpoint as compared to other locations along the pipes 112. Referring now to the temperature sensing system 106, in some embodiments, the temperature sensing system 106 can comprise or include one or more linear temperature sensors. Further, in some embodiments, the temperature sensing system 106 can comprise a distributed temperature sensing (DTS) system, which can be configured to sense temperatures at multiple data points along the length of an optical fiber 126. Accordingly, as shown in FIGS. 1 and 2, the optical fiber 126 can be arranged throughout the pipeline system 102, such as on one or more outer surfaces of the pipes 112. Alternatively or additionally, in some embodiments, the optical fiber 126 can be arranged inside the pipes 112.

In some embodiments, the optical fiber 126 may be installed along substantially the full length of the pipeline system 102. Accordingly, with reference to FIG. 1, the optical fiber 126 can be placed on the pipes 112A, 112B, 112C near the valve 118 to obtain a temperature associated with the fluid 114 at the valve, near the flange 120 to obtain a temperature associated with the fluid 114 at the flange, and near the pipe anchor 122 to obtain a temperature associated with the fluid 114 near the pipe anchor 122. Thus, the temperature sensing system 106 can determine and output temperature values associated with the fluid 114 in the first pipe 112A, the second pipe 112B, and/or the third pipe 112C, and/or at specific components of the pipeline system 102, to the management system 108. In other embodiments, the optical fiber 126 is installed along a portion of the full length of the pipeline system 102.

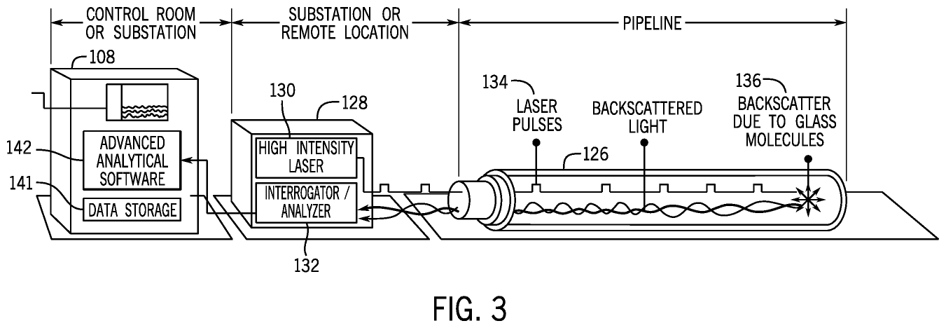

In some embodiments, as shown in FIGS. 1 and 2, the temperature sensing system 106 further includes a signal controller 128 (e.g., a “DTS unit”). A more detailed hardware diagram of the DTS system 106, including the signal controller 128 and the optical fiber 126, is shown in FIG. 3. Generally, the signal controller 128 can be configured to provide a laser source to the optical fiber 126 and to process signals from the optical fiber 126 in order to determine a plurality of temperature values at various locations along the optical fiber 126.

More specifically, as shown in FIG. 3, the optical fiber 126 can be located along the pipeline system 102 and can be coupled to the signal controller 128, e.g., via a transit cable (not shown for clarity). The signal controller 128 can include a high intensity, pulsed laser 130 and an interrogator/analyzer 132. In some embodiments, the signal controller 128 can be located remote from the pipeline system 102, such as at a substation. The signal controller 128 can further be coupled to the management system 108 which, in some embodiments, can include an industrial personal computer rack with data storage 141 and a controller 142 with a processor capable of executing software programs, and which can be located at a substation or a separate control room.

As shown in FIG. 3, the signal controller 128 can emit laser pulses through the optical fiber 126 via the laser 130 and can receive backscattered light via the interrogator/analyzer 132. For example, the pulsed laser 130 is coupled to the optical fiber 126 through a directional coupler (not shown). The pulsed laser 130 can generate laser pulses 134 at a high frequency (e.g., every 10 ns). Light is backscattered as each pulse 134 propagates through the core of the fiber 126, owing to changes in density and composition as well as molecular and bulk vibrations. A mirror (not shown) or any other desired reflective surface may be used to direct the backscattered light 136 to analyzer 132. The velocity of light propagation in the optical fiber 126 is well defined and modeled, and the distance that the pulse 134 travels along the fiber 126 before being reflected (e.g., partially) as backscattered light 136 can be calculated by the analyzer 132 using the deterministic collection time of the backscattered light 136 and reflectometry methods such as optical frequency domain reflectometry (OFDR) or optical time domain reflectometry (OTDR). For example, the interrogator/analyzer 132 is able to measure and analyze backscattered light 136 and can be, for example, a specialized Optical Time Domain Reflectometer that includes software to analyze specific spectral signals for distributed or point temperature information. Thus, a temperature of the pipeline 102 and a distance along the pipeline 102 associated with this temperature can be determined simultaneously from the backscattered light 136. Furthermore, the signal controller 128 can output the temperature and location values to the management system 108.

While the systems 100 illustrated in FIGS. 1 and 2 include a single optical fiber 126 running the length of the pipeline system 102, in some embodiments, multiple optical fibers 126 can be used. According to one example, the temperature sensing system 106 can include a first optical fiber 126 lying on top of the pipeline and a second optical fiber 126 that lies along a bottom of the pipeline. As a result, in such embodiments, a temperature gradient over the pipeline cross-section may be determined based on temperature data from the dual optical fiber lines 126.

Accordingly, the temperature sensing system 106, in the form of a DTS system, can provide thermal intelligence by monitoring the temperature along the entire pipeline 102. More specifically, the DTS system can monitor temperatures, for example, at every meter segment of the pipeline 102 and, in some embodiments, may also monitor temperatures at one or more “off-pipe” areas, e.g., to be used as ambient temperature measurements.

Referring back to FIGS. 1 and 2, with reference now to the heating system 104, in some embodiments, the heating system 104 can heat the pipeline system 102 in order to transfer heat to the fluid 114. In some embodiments, the heating system 104 can include one or more heat trace cables 138 such as, but not limited to, standard heating cables, self-regulating heating cables, power-limiting heating cables, skin-effect heating cables, etc. The heat trace cables 138 can be operated by the management system 108, as further described below. In some embodiments, the heat trace cables 138 can be coupled together, in series and/or parallel, so that all of the heat trace cables 138 are energized or not energized in unison. Furthermore, in some embodiments, the heat trace cables 138 or sections thereof can be individually controlled by the management system 108, thus allowing the management system 108 to increase or decrease heating at certain locations along the pipeline system 102.

With reference to the management system 108, in some embodiments, the management system 108 can include at least one controller. The controller can be any controller suitable for receiving inputs from one or more sensors, devices, or sources of data representing temperature or other parameters and can be capable of controlling components of the system 100 such as, but not limited to, the heating system 104, the pump 111, the temperature sensing system 106, etc. For example, in some embodiments, the controller can be a standalone controller such as a microcontroller that can include at least one processor and at least one memory or a programmable logic controller (PLC). The controller can be configured to execute a management program in accordance with one or more of the methods described below.

In some embodiments, the management system 108 can directly control the heating system 104 and/or the temperature sensing system 106, and/or can communicate with and/or provide instructions to dedicated controllers of the heating system 104 and/or the temperature sensing system 106. In some embodiments, the management system 108 can also communicate with other components of the system 100 or outside the system 100 to obtain certain operational parameter including, but not limited to, pump parameters, flow rates (e.g., at pipeline inlets and outlets), valve positions, weather conditions, heating cable parameters (e.g., voltage, current, power output or consumption, etc.), RTD temperature sensor values, etc.

For example, as shown in FIG. 1, the management system 108 can comprise a controller 140 that is coupled to and operates the heating system 104 in order to selectively energize the heating cables 138 and heat the pipeline system 102. For example, the controller 140 can selectively energize one or more of the heating cables 138 based on received temperature values and/or other parameter values, in accordance with the methods described below. As shown in FIG. 1, the controller 140 is in further communication with the signal controller 128 of the temperature sensing system 106.

As another example, as shown in FIG. 2, the management system 108 can comprise a controller 142 (which may include at least one processor and memory) that is part of the process automation system 110. That is, the process automation system 110 can be directly, indirectly, or wirelessly connected to one or more sensors as well as the controller 140, e.g., a dedicated controller of the heating system 104, and the signal controller 128 of the temperature sensing system 106. As a result, for example, the temperature sensing system 106 can output values to the process automation system 110, including one or more temperature values associated with locations in the pipeline system 102. Further, any of the controllers 128, 140, 142 may be capable of analyzing sensor data and outputting control instructions in accordance with the methods described herein. That is, any of the controllers 128, 140, 142 can include a computer readable non-transitory memory that includes instructions (e.g., computer-executable instructions) that may be executed by a processor in order to perform operations in accordance with any of the methods described herein. Additionally, in some embodiments, the pump 111 can be coupled to the process automation system 110 and can be controlled by the controller 142 of the process automation system 110.

As yet another example, FIG. 3 illustrates the management system 108 coupled to the temperature sensing system 106 in order to receive the temperature values and respective locations, e.g., from the signal controller 128. Additionally, in some embodiments, the management system 108 can provide the functionality of and replace the signal controller 128 of the temperature sensing system 106.

Furthermore, in some embodiments, the management system 108 can be coupled to and in communication with a remote device 144, as shown in FIGS. 1 and 2. The remote device 144 can be a user device such as, but not limited to, a desktop computer, a smartphone, a tablet computer, etc. For example, the management system 108 (i.e., the controller 140/142) can communicate with the remote device 144 to send and/or receive data, control instructions or algorithms (including software updates), alerts, warnings, etc. In some embodiments, the remote device 144 can be in communication with the management system 108 via a communications system such as the internet, a wide-area-network, or a local-area-network.

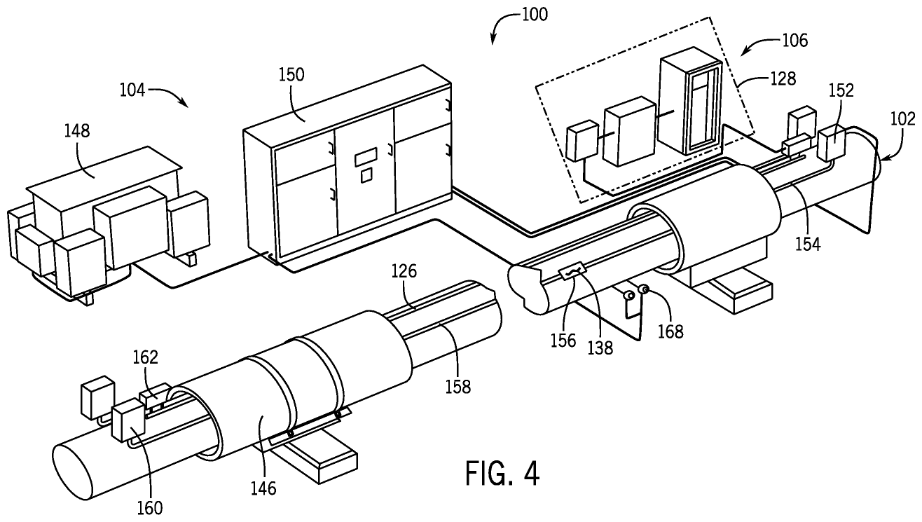

FIG. 4 illustrates another control system 100 and, more specifically, a skin effect heat management system, according to some embodiments. As shown in FIG. 4, the control system 100 can be used with a pipeline system 102 and can include a heating system 104 and a temperature sensing system 106. The pipeline system 102 can include one or more pipes 112 and anchors 122. In some embodiments, the pipe 112 can be a pre-insulated pipe, which may be surrounded by composite thermal insulation and cladding 146. A pre-insulated pipe 112 may, for example, may provide higher quality, construction schedule improvements, ease of installation, lower installed cost, durable construction, and reduced maintenance compared to uninsulated pipes.

Referring still to FIG. 4, the heating system 104 can be a skin effect heat tracing system (STS), including a transformer 148, a control panel 150 (e.g., part of or in communication with a management system 108, not shown in FIG. 4), one or more power connection boxes 152, one or more heat tubes 154 (e.g., incorporating one or more skin effect heating cables 138 routed therethrough), one or more pullboxes and/or splice boxes 156, one or more couplings 158, and one or more end termination boxes 160. The heat tubes 154 can be disposed along the length of pre-insulated pipe 112. The heat tubes 154 may act as heaters for the pipe 112 and may receive power from a power source (not shown) through the transformer 148 and the power connection boxes 152. That is, power may be selectively applied (e.g. using switching circuitry) to the heat tubes 154 through the power connection boxes 152 based on control signals generated by a controller (such as controller 140 of FIGS. 1 and 2) in the control panel 150. These control signals may be generated automatically during the regular course of maintaining a temperature of the fluid 114 in the pipe 112 around, e.g., a predetermined setpoint temperature, such as a temperature that exceeds the nominal melting point of the process fluid by a predetermined amount. For example, since Sulphur will begin to freeze at temperatures around 119° Celsius (C), a Sulphur pipeline may be operated to maintain a setpoint temperature between 135° C. and 108° C.

Additionally, as shown in FIG. 4, the temperature sensing system 106 can be a fiber optic-based DTS system to measure temperature across the pipe 112. For example, the temperature sensing system 106 can include an optical fiber line 126 with associated processing circuitry in a signal controller 128, and one or more associated fiber optic splice boxes 162, fiber optic pull boxes 164, and/or fiber optic end boxes (not shown). The signal controller 128 can include a frequency generator, a laser source, an optical module, a high frequency mixer, a receiver, and a microprocessor unit, and may be coupled to the fiber optic line 126 disposed along the pipe 112, for example, through a fiber optic splice box 162. DTS data (e.g., spatio-temporal temperature data for the pipeline 102) may be generated through the analysis of backscattered signals, as described above, with each data point of the DTS data representing a temperature of the pipeline 102, the time at which the temperature was measured, and the location along the pipeline 102 at which the temperature was measured.

Additionally, one or more discrete temperature sensors, such as resistance temperature detectors (RTDs, such as platinum RTDs) 168 may optionally be included along pipe 112. The RTDs 168 can generate RTD temperature data, separate from the temperature data generated by the DTS system, which may be used by the management system 108 for verification of the DTS data (e.g., to ensure that the DTS data is reasonably accurate). Furthermore, in some embodiments, temperature sensors (or optical fiber lines 126) may also be routed through heating cable splice boxes 156. Furthermore, it should be noted that the optical fiber line(s) 126 and associated hardware and circuitry in any of the above described embodiments may be installed during pipeline install or retrofit onto existing systems.

Furthermore, in some embodiments, the system 100 can further include one or more different types of sensors for generating pipeline data and other dynamic information, e.g., which may be sent to and received by the management system 108. These sensor inputs may include both distributed and/or discrete measurements, and may generate data describing the process fluid 114 and its flow, as well as the status of different system components such as the heating system 104, the temperature sensing system 106, pipe insulation 146, various sensors, and the pipe sections themselves. For example, the system 100 can include one or more sensors configured to generate pipeline data such as heating cable power outputs, pump status, pressure, flow rate, heating cable voltages, heating cable currents, alarm signals (e.g., pump alarm signals, high pressure alarm signals, etc.) or others.

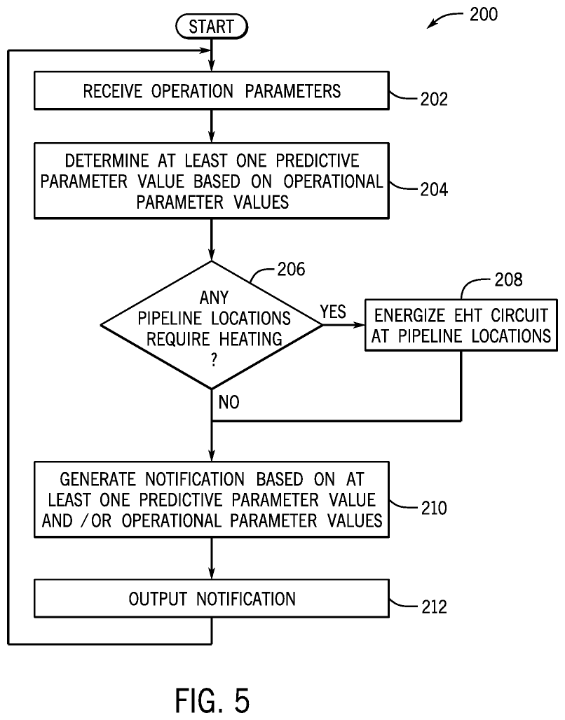

FIG. 5 illustrates an exemplary process 200 for monitoring a pipeline 102. The process 200 can be stored as computer readable instructions on a memory of a computational device, e.g., of the management system 108 (such as the controller 140 or 142). For example, the process 200, and/or any of the methods described herein, can be part of a software package that is stored on and executed by the management system 108.

Accordingly, the process 200 will be described below with reference to being executed by the controller 142 of the process automation system 110, but can instead be executed by another controller of the system 100 in some embodiments. Additionally, analysis of certain data values may be performed by a combination of one, two, or three controllers 128, 140, and/or 142. Furthermore, all values read, determined, or otherwise obtained by any of the controllers 128, 140, 142 can be stored in memory, such as non-transitory memory of the management system 108.

Generally, at step 202, the controller 142 can receive one or more operational parameter values. At step 204, the controller 142 can determine at least one predictive parameter value based on the operational parameter value(s). At step 206, the controller 142 can determine if any pipeline locations require heating based on the at least one predictive parameter value. If so, at step 208, the controller 142 can energize one or more heating cable circuits at the one or more pipeline locations. If not, or after energization commands are sent at step 208, the controller 142 can proceed to step 210 and generate a notification based on the operational parameter value(s) and/or the at least one predictive parameter value. At step 212, the controller 142 can output the notification to a display of the management system 108 or to one or more remote devices 144.

More specifically, with respect to step 202, the controller 142 can receive one or more operational parameter values. In some embodiments, the operational parameter values can include temperature values, e.g., received from the temperature sensing system 106. Other operational parameter values can include values of operational parameters such as alarm signals (e.g., pump alarm signals, high pressure alarm signals, etc.), heater cable power outputs, pump status, pressure, flow rate, heater cable voltages, heater cable currents, supplementary temperature readings, physical pipeline parameters (e.g., high or low elevations, elbows, curves, etc.) and other suitable parameters. In some embodiments, operational parameter values can be obtained from sensors or meters, calculated or estimated based on other parameters, or otherwise determined. For example, flow rate may be obtained from a flow meter within the pipeline 102, or otherwise obtained without requiring a flow meter. Additionally, in some embodiments, operational parameter values can include parameters outside the pipeline 102, such as ambient temperature or weather data.

At 204, the controller 142 can determine at least one predictive parameter value based on the operational parameter values. The at least one predictive parameter value can include one or more values of parameters such as percentage fill, phase status, flow status, pipeline plug formation detection and/or location, pipeline heat loss coefficient, pipeline insulation health, pipeline anchor health, pipeline rupture points, hot or cold spots, time-to-freeze, re-melt status and time until re-melt, time to reach operational limits, heater cable health, DTS system health, melt uniformity, and/or solid Sulphur distribution.

Certain predictive parameter values can be determined based on the temperature values with related time and locations (considered “DTS data”), such as by analyzing trends of temperature values over time at pipelines locations. For example, the controller 142 can determine hot spots, cold spots, pipeline plug formation detection, pipeline plug formation locations, time-to-freeze, freeze detection, rupture points, and/or percentage fill based, at least in part, on the temperature values. Other predictive parameter values can be determined based on the temperature values as well as additional information such as alarm signals, heater power outputs, pump status, pressure, flow rate, heater cable voltages, heater cable currents, and/or supplementary temperature readings.

For example, the controller 142 can determine percentage fill (e.g., pipe percentage fill) based on the temperature measurements, flow rate(s) of the pipeline 102, heater operational data, ambient temperature measurements, and/or weather data. More specifically, a cooling rate of the temperature values can vary based on how full of fluid the pipeline 102 is and, thus, percentage fill may be determined at least by looking at relative temperature rates of change and/or by also factoring in flow rate, heater operation, ambient temperature, and/or weather data. As another example, using a dual-optical fiber setup, if the pipeline 102 is full, a temperature sensed should match the actual fluid temperature. However, if the pipeline is not completely full, a temperature gradient may form between the top of the pipe 112 and the bottom of the pipe 112. In some embodiments, percentage fill may be output as a percentage between 0% and 100%, inclusive. In other embodiments, percentage fill may be output as a relative value, such as “full,” “partially full,” or “empty.”

In some embodiments, the controller 142 can determine phase status of the fluid 114 at locations along the pipeline 102 based on sensed temperature trends. This phase status may alternatively be considered freeze detection. For example, the controller 142 can determine that the process fluid 114 is beginning to solidify in the pipe 112 by comparing a latent heat signature stored in memory to the temperature data over a time period. That is, the controller 142 can identify one or more latent heat signatures in the extracted temperature data that match the stored latent heat signature. Latent heat signature-based analysis may be beneficial when used in conjunction with pipelines carrying process material, such as Sulphur, that does not freeze at a discrete temperature, but instead freezes at some temperature within a temperature range (e.g., 114-120° C. in the case of Sulphur). For example, monitored temperature accuracies, make-up of process fluid, size of pipe (considering that fluid does not freeze all at once) are but some considerations that affect the actual monitored temperature at which the process fluid will freeze.

Accordingly, the controller 142 can identify the latent heat signature of the actual phase transition, independent of the process fluid's measured temperature, from the DTS data in order to identify phase transitions as they occur in the pipeline 102. That is, a latent heat signature can be a particular rate of change (e.g., within a certain temperature range) that is specific to the process fluid and indicative of a phase change. As an example of a latent heat signature associated with a liquid-to-solid phase change of Sulphur, a transient upward temperature spike may be detected at a location along the pipeline at which Sulphur is transitioning from liquid to solid (e.g., freezing). As an example of a latent heat signature associated with a solid-to-liquid phase change of Sulphur, a continuous temperature decrease may be detected at a location along the pipeline at which Sulphur is transitioning from solid to liquid (e.g., melting). In some embodiments, the latent heat signature unique to the process material 114 can be determined and generated during initial deployment of the pipeline 102 as a process material undergoes its phase changes within the pipeline, and at different points along the pipeline 102.

In some embodiments, the controller 142 can determine flow status based on DTS data. For example, the controller 142 can determine if the pipelines 102 is, or has recently been, flowing using only the DTS temperature data. For example, the controller 142 can analyze DTS data to monitor variations from segment to segment (e.g., meter to meter segments) across a fixed length of pipeline. This determination can work well for applications where there is sufficient heat loss variation along the pipeline 102, and where the pipeline temperature is sufficiently higher than ambient so that the temperature distribution along the pipeline 102 varies by several degrees when the pipeline 102 is in a non-flowing thermal equilibrium state.

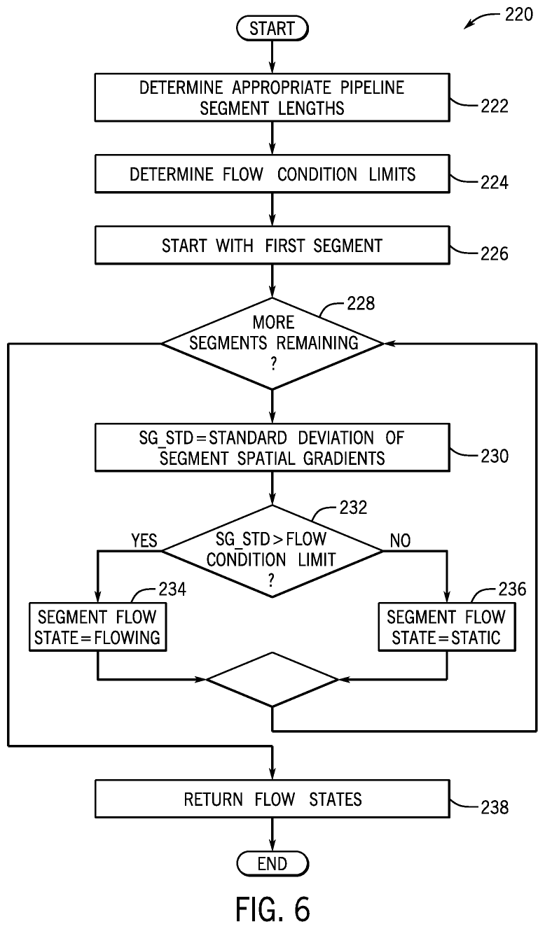

FIG. 6 illustrates an example process method 220 for determining flow status. As shown in FIG. 6, at step 222, the controller 142 can determine (or retrieve from memory) pipeline segment lengths. In some embodiments, such lengths may be uniform lengths, such as 1-meter segments, 2-meter segments, 3-meter segments, up to 100-meter segments or more. In other embodiments, such lengths may vary depending on a specific geometry or physical attributes of the piping system 102. At step 224, the controller 142 can determine (or retrieve from memory) flow condition limits. For example, such limits can be derived (and/or updated) during commissioning or other modeling and dependent on the process fluid, pipeline diameters, and/or other variables. At step 226, the controller 142 can pull a first segment of the pipeline 102 as a selected segment. At step 228, the controller 142 can query whether any segments in the pipeline 102 remain. If so, at step 230, the controller 142 determines a standard deviation of segment spatial gradients. At step 232, the controller 142 compares the standard deviation to the flow condition limit obtained at step 224. If the standard deviation is greater than the flow condition limit, the controller 142 determines that there is flow in the selected segment (i.e., the segment flow state is “flowing”) at step 234. If the standard deviation is less than the flow condition limit, the controller 142 determines that there is no flow in the selected segment (i.e., the segment flow is “static”) at step 236. The controller 142 then returns to step 228 to query whether any segments in the pipeline 102 remain. If so, the controller 142 proceeds to step 230 and determines a standard deviation of segment spatial gradients with respect to a subsequent selected segment. If no segments remain at step 230, the controller 142 proceeds to step 238 and returns the flow states of the segments of the pipeline 102 as predictive parameter values.

Returning back to step 204 of FIG. 5, in some embodiments, the controller 142 can determine pipeline plug formation detection (e.g., “plugged,” “partially plugged,” and/or “not plugged”) and/or pipeline plug formation location based on determined fill percentage levels along the pipeline 102, phase statuses, and/or flow statuses as described above. For example, the controller 142 can determine a plug is present or absent based on a 100% fill, a solid phase status determination, and/or a static flow determination (e.g., based on one of these parameters or a combination of these parameters). As another example, the spatial variance of temperature data of a segment of pipeline 102 containing liquid Sulphur may be very low with little noise. However, this can be in sharp contrast to the relatively higher variance seen in data for an empty section of the pipe. Thus, the controller 142 may analyze such variance to determine plug formations. Furthermore, in some embodiments, a combination of inputs (e.g., pump running, pressure normal, flow stopped, DTS temperature variance) can allow the controller 142 to determine the presence (e.g., occurrence) and precise location of the plug.

In some embodiments, the controller 142 can determine an effective pipe heat loss coefficient based on the temperature values, flow rate(s) of the pipeline 102, and/or heater operational measurements. For example, by examining steady-state periods in the pipeline 102, the controller 142 can determine the heat loss coefficient based on linear regression to determine mean effective ambient temperature, mean pipeline temperature, and mean power consumption, and identify if an element changes due to non-ambient conditions (e.g., a pipe going through tunnel suddenly gets buried/surrounded by sand). For example, mean effective ambient temperature can be calculated by taking into account weather conditions from weather data (e.g., wind, precipitation, and/or solar effects) or from off-pipe temperature measurements (e.g., from the DTS system). The heat loss coefficient can be equal to mean power consumption divided by (mean pipe temperature minus effective ambient temperature). Such calculations can be done on a meter-by-meter basis, for example, for each meter of the pipeline 102. Additionally, in some embodiments, the above calculations can be separately performed on spatially continuous sections a respective heater zone of the heating system 104.

In some embodiments, the controller 142 can determine pipeline insulation health or performance integrity, e.g., in order to identify and/or locate pipe insulation failures and/or potential or pending failures. According to one example, pipeline insulation health can be determined based on the determined effective pipe heat loss coefficient, e.g., comparing the heat loss coefficient to a stored baseline value, such as on a meter-by-meter or segment-by-segment basis. In some applications, the stored baseline value may be updated, for example, to reflect normal wear on the pipeline. As another example, the controller 142 can identify the location of wet insulation 146 along the pipeline 102 based on the temperature data. As yet another example, pipeline insulation health for pipeline segments can be determined based on thermal conductivity and temperature rates-of-change, e.g., against a stored baseline value.

In some embodiments, the controller 142 can determine pipeline anchor health based on a spatial shift in temperature values. More specifically, pipeline anchors 122 can “pop” off anchor points and physically move, which may be reflected in the temperature values. For example, as described above, anchors 122 are generally cool spots in the pipeline 102. Therefore, if a measured cool spot shifts to a different segment, this observed shifting pattern can indicate an issue with the anchor 122. Thus, the controller 142 can determine that an anchor 122 has shifted based on the temperature values illustrating a specific pattern (e.g., stored in memory) or, more specifically, by comparing changes in temperature values at and/or adjacent to a known anchor segment to a stored pattern.

In some embodiments, the controller 142 can determine pipeline ruptures and/or other failures using the temperature values. For example, air flowing (e.g., backfilling) into a pipeline 102 can cool the pipeline 102 in a detectable pattern. The controller 142 can thus analyze past temperature values at a given segment along the pipeline 102 (e.g., on a meter-by-meter basis) and compare the temperature values to a predetermined (i.e., stored in memory) pattern indicative of a rupture. If the past temperature values are similar to the predetermined pattern, the controller 142 can determine that a rupture has occurred and/or a location of the rupture. Such patterns, for example, can reflect extreme changes in temperature over a short time period over a specific segment.

In some embodiments, the controller 142 can determine hot spots and/or cold spots (heat sinks) using the temperature values. For example, the controller 142 can compare past temperature values at a given segment along the pipeline (e.g., on a meter-by-meter basis) and compare the temperature values directly or to a predetermined pattern or trend. Based on the comparison (e.g., based on temperatures changing at a predefined rate), the controller 142 can determine hot or cold spots present at specific segments, and/or predict that a hot or cold spot is likely to form at a specific segment. The controller 142 can also consider ambient temperature and/or heating system status in hot and cold spot determinations, such that different patterns or trends may be used in the temperature comparison based on ambient temperature values and/or heater energization status. Such information can assist with adjusting physical attributes of the pipeline 102 before bigger failures occur, such as a rupture.

In some embodiments, the controller 142 can determine a time to freeze based on DTS data alone or in combination with ambient temperature, and/or heating system status (e.g., energy input to the heating cables). For example, time to freeze may be a predicted number (e.g., hours and/or minutes) for a pipeline segment to reach a liquid-to-solid phase change temperature. For example, the controller 142 can determine the predicted number by extrapolating a time to reach a liquid-to-solid phase change temperature based on determined trends in the DTS data and, optionally, while also taking into account ambient temperature and/or heating system status.

The controller 142 can also determine a re-melt status or time until re-melt is complete based on an energy input to the heating cables and a predetermined temperature loss profile. For example, time until re-melt is complete may be a predicted number (e.g., hours and/or minutes) for a pipeline segment to reach a liquid temperature.

The controller 142 can further determine a time to reach operational temperature limits. For example, the controller 142 can remove noise and fit a line to monitored temperature gradients over time using linear regression so that extrapolation can be performed to determine a time that an operational temperature limit is reached (e.g., assuming outside conditions do not significantly change or accounting for changes in outside conditions, such as weather). Such information can be used, for example, for localized heating optimization of the fluid 114 within the pipeline 102 to deliver the fluid 114 (e.g., to a plant) within an optimal temperature window.

In some embodiments, the controller 142 can determine skin effect heating system health based on DTS data, heater cable voltages, heater cable currents, and/or heater cable power consumption. For example, skin effect heating cable impedance can change with cable temperature. The controller 142 can compare observed heater power consumption with predetermined “ideal” or “expected” heater power consumption (e.g., based on temperature data), to identify poor skin effect heater system health. Additionally, in some embodiments, the controller 142 can determine skin effect heating system health based on a temperature of a splice box housing a portion of the skin effect heating cable, as higher splice box temperatures can indicate relatively poor skin effect heater system health.

Additionally, in some embodiments, the controller 142 can monitor heater cable operation to detect areas that are not properly heating. For example, the controller 142 can compare temperature trends in individual segments against overall temperature trends of the full heater cable length. If the segment trends do not follow the overall trends, such anomalies may be indicative of the segment not properly heating.

In some embodiments, the controller 142 can determine DTS system health in order to determine an amount of performance degradation of the optical fiber(s) over extended periods of time. For example, the controller 142 can measure fiber attenuation (e.g., signal fidelity) against a commissioned baseline value for the entire length of the optical fiber line over time. As another example, the controller 142 can record historical process fluid temperatures during routine operations and excursion events. As new temperature data is generated and obtained, this new temperature data may be verified in order to ensure that the measured temperatures are within a reasonable range based on predefined ranges or baselines that may be stored in the non-transitory memory. This verification may be performed on the new temperature data before the new temperature data undergoes further analysis as described above and before the new temperature data is stored as part of the historical temperature data in the non-transitory memory. If the new temperature data is successfully verified, the analysis and storage continues normally. Otherwise, if the new temperature data does not pass verification (e.g., the new temperature data is outside of the predefined ranges), the new temperature data may be discarded and does not undergo further processing or storage.

Additionally, in some embodiments, the controller 142 can determine melt uniformity as a comparative analysis of phase changes along the pipeline 102. For example, the controller 142 can determine an amount of process fluid 114 in the pipeline 102 that is fluid or solid and approximate locations of such phases based on DTS data (such as percent fill data). Furthermore, in some embodiments, the controller 142 can determine a solid Sulphur distribution, for example, as aggregated locations of frozen process fluid 114 (e.g., Sulphur) in the pipeline. More specifically, the controller 142 can determine segments of frozen Sulphur and aggregate adjacent segments to output section lengths of frozen Sulphur. This allows the controller 142 to communicate to an operator whether, for example, a one-meter section of pipeline 102 is frozen or a full 50-meter section of pipeline 102 is frozen.

Furthermore, generally, in light of the above, the controller 142 can determine trends (e.g., historical patterns) of any of the operational parameter values and/or the predictive parameter values described herein.

Referring back to the process 200 of FIG. 5, at step 206, the controller 142 can determine if any pipeline segment locations require heating based on the at least one predictive parameter value. For example, the controller 142 may determine that heating is required based on plug formation, flow status, hot or cold spots, time-to-freeze, etc. If the controller 142 determines that one or more pipeline locations require heating (e.g., “YES” at 206), the controller 142 can proceed to step 208. If the controller 142 determines that no pipeline locations require heating (e.g., “NO” at 206), the controller 142 can proceed to step 210.

At step 208, the controller 142 can energize one or more heating cable circuits at the one or more pipeline segment locations as determined at step 206. For example, the controller 142 can determine one or more heating cable commands to implement controlled re-melting of frozen areas of the pipeline 102 based on the temperature values in order to prevent pipeline rupture. As another example, the heating cable commands can include staged temperature increase to prevent rupture based on a predefined (e.g., stored) profile that factors in one or more operational parameters.

Step 208, as described above, indicates an automated process for pipeline heating and re-melt. In some embodiments, however, the process 200 may provide assistance for manual heating operations. In such embodiments, at step 208, the controller 142 may instead determine optimal heating cable commands to maintain a uniform thermal profile along the pipeline and/or to achieve a staged temperature increase to prevent rupture based on a predefined (e.g., stored) profile that factors in one or more operational parameters. In such embodiments, the optimal heating cable commands become predictive parameter values for use in steps 210 and 212 below.

Following step 208 or if no heating is required as determined at step 206, the controller 142 can proceed to step 210 and can generate one or more notifications based on the at least one predictive parameter value and/or the at least one predictive parameter value. For example, the controller 142 can generate a notification regarding detected ruptures, temperatures, pipeline component health (e.g., insulation health and/or anchor health), frozen areas, or any other suitable parameter value determined at step 204 and/or received or otherwise obtained at step 202. In some embodiments, the notification(s) can include graphs, charts, text instructions, and/or other infographics generated based on the at least one predictive parameter value and/or the at least one operational parameter value. The notification may be in the form of a report, chart, graph, alert, alarm, warning, etc.

At step 212, the controller 142 can output the notification to one or more remote devices 144 and/or to a display of the management system 108 (e.g., a display 143 as shown in FIG. 2). In some embodiments, specific notifications can be output to one or more remote devices 144 and/or the management system 108 based on the type of notification. For example, in some embodiments, one or more notifications can be presented in a graphical user interface (GUI) implemented by the remote device 144 and/or the management system 108. In some embodiments, some notifications, such as alarms or warnings can be output only to certain remote devices 144 (e.g., via email, push notifications, text message, application notifications on a tablet or smart phone, etc.). Notifications can include displays, as noted above, and/or sounds.

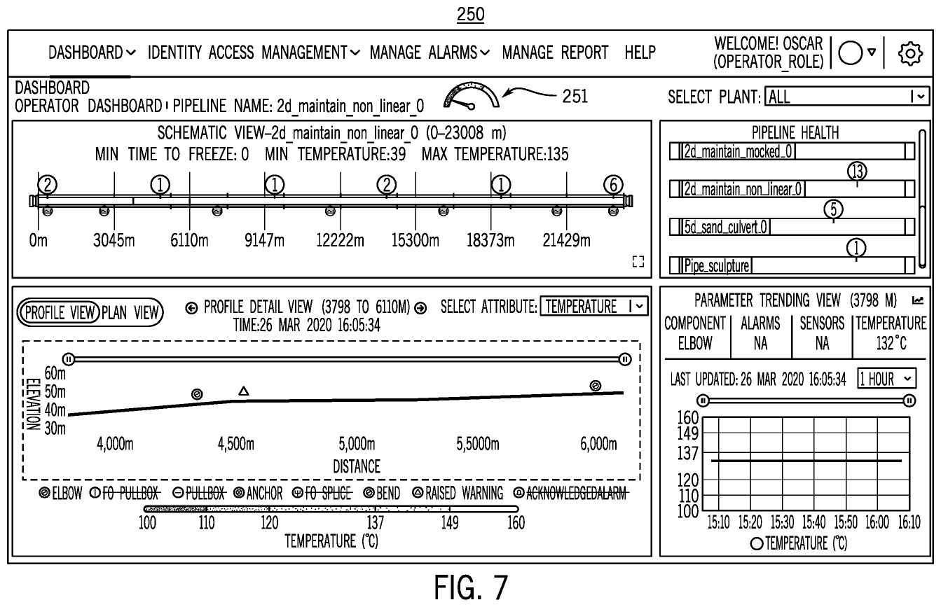

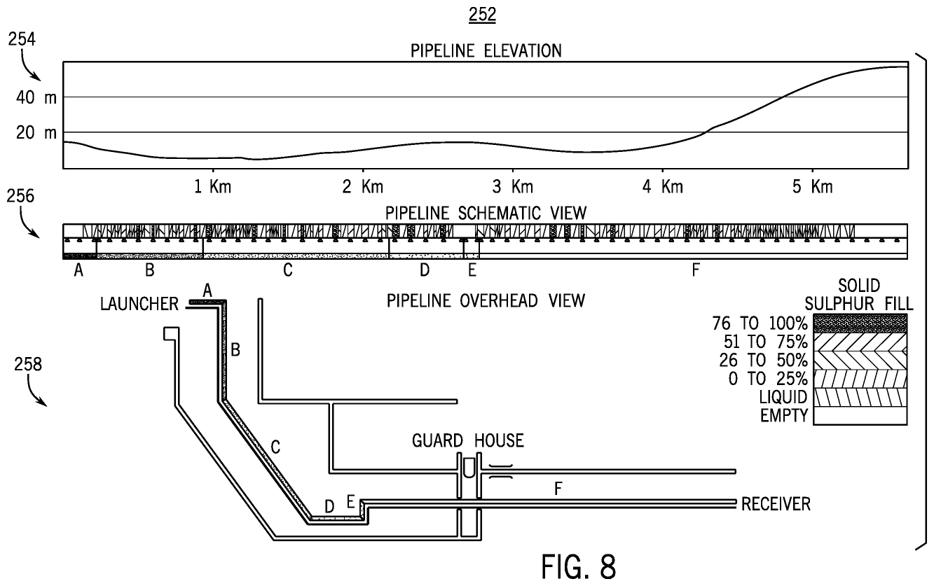

For example, FIGS. 7 and 8 illustrate example notifications output via the controller 142 in the form of GUIs. More specifically, FIG. 7 illustrates a GUI 250 for use with pipeline monitoring in some embodiments. The GUI 250 can be presented as an “operator dashboard” and can include values of parameters associated with the pipeline such as minimum time to freeze, minimum temperature, maximum temperature, temperature along the pipeline, pipeline health, alarms, and/or parameter value trends. The GUI 250 can include visual indicators of pipeline features such as elbows, anchors, bends, pullboxes, and/or splices. In some embodiments, the GUI 250 can further include a visual profile of the pipeline 105 with associated parameters, such as a temperature profile along pipeline length, elevations, etc. Furthermore, in some embodiments, in addition to including alarm values, the GUI 250 can provide an alarm management system for a user to manage such alarms. The GUI 250 can further provide a parameter trend view for one or more selected parameters (e.g., a graph of parameter values over a time period along a specific segment). Furthermore, in some embodiments, trend analyses can be provided based on the parameter trends provided. Accordingly, the GUI 250 can allow operators to immediately identify the current state of the pipeline 102 and to initiate appropriate responses or actions, e.g., as recommended by the controller 142.

FIG. 8 illustrates yet another exemplary GUI 252 for use with pipeline monitoring in some embodiments. The GUI 252 can include a graph 254 of Sulphur fill percentage over a length of a pipeline 102 as well as a schematic pipeline model 256 view indicating fill along pipeline segments. The GUI 252 can also include a corresponding overhead model view 258 of pipeline elevation over the length of the pipeline 102 to help an operator better visualize the segments.

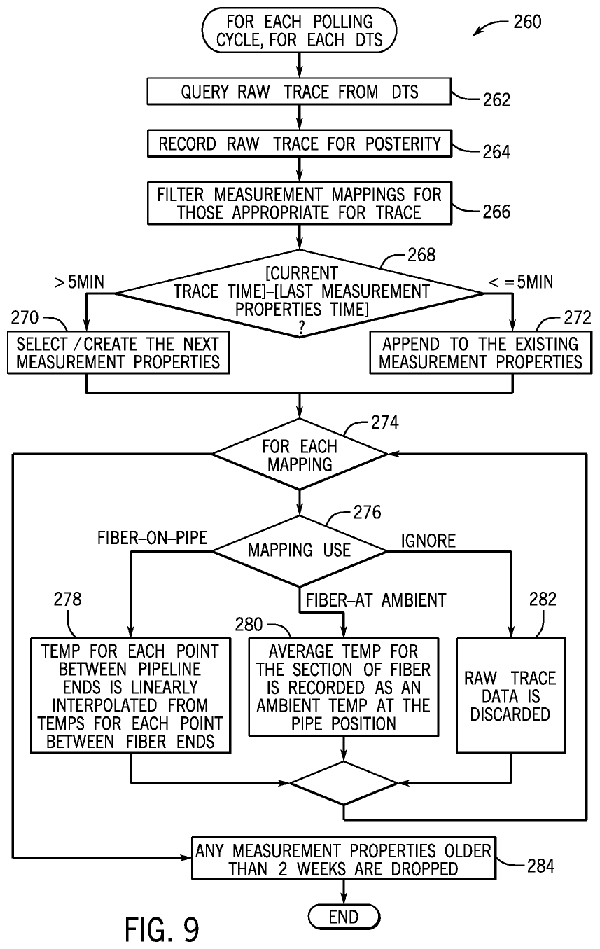

In some embodiments, as noted above, a GUI can provide one or more pipeline model views to allow an operator to better understand exactly what parts of the physical installation may be indicated. The pipeline model can include lengths, positions, material components, and/or other notable features of the pipeline 102 so that the operator can correlate to the physical installation. The controller 142, therefore, can map raw data from operation or predictive parameters to the pipeline model. For example, a length of fiber optic cable 126 may not necessarily match a measured length of pipeline 102 (e.g., due to stretching, loosening, snaking, loop-backs, lead-ins and lead-outs, pull-boxes and splice-boxes, etc.), the fiber optical cable 126 may shift after initial commissioning. Also, not all of the fiber optic cable 126 is on the pipeline 102 itself, such that some DTS data refers to pipeline temperatures, some DTS data refers to off-pipe (e.g., ambient temperatures), and some DTS data may not reference usable temperature data. Furthermore, the temperature sensing system 106 may sense temperatures at different length intervals. In light of these variables, FIG. 9 illustrates a process 260 to correlate a generated pipeline model to a physical installation.

More specifically, with reference to the process 260 of FIG. 9, the controller 142 can consider a chain length of the pipeline 102, e.g., a measured length of the physical equipment from a specified start point. Measurement mappings can describe what length of optical fiber 126 is attached to what section of the physical installation and, by extension, to the pipe model. For example, these measurement mappings can be manually modelled during commissioning (e.g., based on pipeline drawings and physical observations). A measurement property can refer to fixed data structure for each chain length segment of the pipeline, for each temporal interval up to a configured maximum interval. As further described below, raw trace data (e.g., DTS data) is mapped to this structure, and an effective distance along the pipeline 102 for sensed temperatures can be calculated using ratios from this mapping.

Still referring to FIG. 9, at step 262, the controller 142 can query raw trace data from the DTS system 106. In some embodiments, the controller 142 can record the raw data, e.g., for posterity at step 264. At step 266, the controller 142 can filter measurement mappings to determine those appropriate for the trace. At step 268, the controller 142 can compare the current trace time to the time of the last measurement. If the comparison results in greater than a predetermined time, such as five minutes, the controller 142 can create a next measurement property at step 270. If the comparison results in less than or equal to the predetermined time, the controller 142 can append to existing measurement properties at step 272. For each mapping, as considered at step 274, a mapping use is determined at step 276. More specifically, at step 278, a mapping use can be considered fiber-on-pipe, in which the temperature for each point between the pipeline ends in the mapping is linearly interpolated from the temperature for each point between the fiber ends. At step 280, a mapping use can be considered fiber-at-ambient, in which an average temperature for the section of fiber is recorded as an ambient temperature at a pipe position. At step 282, the mapping use can be considered unusable raw trace data, which can be ignored and discarded. These mapping uses (e.g., steps 276-282) can be repeated for each mapping. In some embodiments, at step 284, measurement properties older than a certain time period (e.g., two weeks) can be discarded.

In addition to a pipeline model, in some embodiments, a heater status can be displayed via a GUI (such as one of the GUIs 250, 252 described above). More specifically, a heater status can include pipeline heating system energization charted relative to real-time temperature profiles of segments of the pipeline 102. Such a view can allow an operator to better understand potential causes of certain temperature profiles.

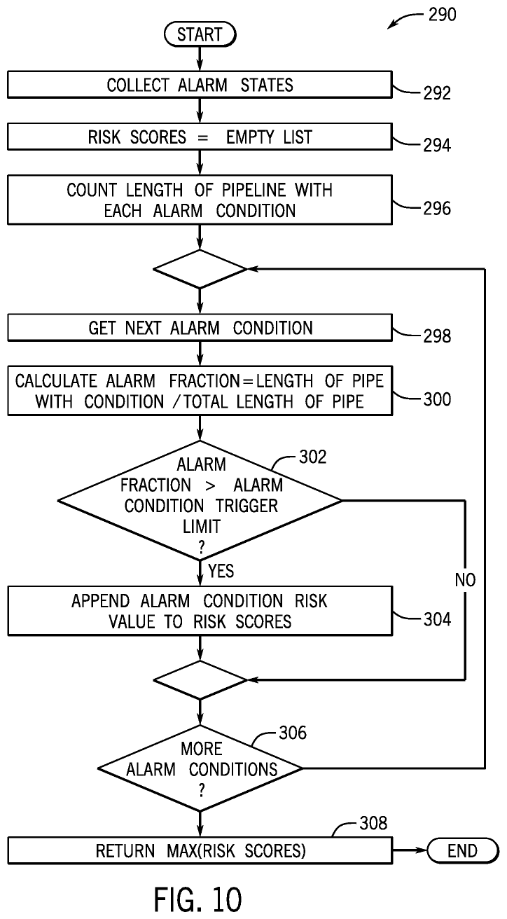

Furthermore, in some embodiments, a health gauge can be displayed via a GUI (such as one of the GUIs 250, 252 described above). More specifically, the health gauge can provide an instantaneous “risk level” or “score” of the pipeline 102. For example, the controller 142 can execute a process, such as process 290 illustrated in FIG. 10, that calculates a risk score (e.g., from 0 to 100, with 100 being the highest possible risk). In this manner, “risk” refers to a risk to sustaining pipeline operations based on, for example, alarm states determined by the controller 142 with respect to a weighting table.

More specifically, with reference to the process 290 of FIG. 10, at step 292, the controller 142 can collect alarm states. At step 294, the controller 142 can initiate the risk score as an empty list. At step 296, the controller 142 can count a length of the pipeline 102 with each alarm condition (e.g., based on determined segments having alarm conditions). At step 298, the controller 142 can retrieve a specific alarm condition. At step 300, the controller 142 can calculate an alarm fraction as a length of the pipeline 102 with the alarm condition divided by a total length of the pipeline 102. At step 302, the controller 142 can determine if the alarm fraction is greater than an alarm condition trigger limit (e.g., a predefined or stored limit). If so, the controller 142 proceeds to step 304 and adds to the risk score a predefined alarm condition risk value. For example, alarm condition risk values, specific to each alarm condition, may be predefined and stored in memory, such as in a table of alarm condition risk values. These values can be weighted based on the type of alarm condition. Following step 304, or if the alarm fraction is not greater than the alarm condition trigger limit as determined at step 302, the controller 142 determines if there are more alarm conditions at step 306. If so, the controller 142 returns to step 298 to retrieve a next alarm condition and repeat steps 300-306. If not, the controller 142 returns a final risk score (e.g. a maximum calculated risk score). In some embodiments, the numerical value of the final risk score can be displayed via a GUI. Additionally or alternatively, the final risk score can be displayed via the GUI, for example, as an infographic. In some embodiments, the final risk score can be displayed as a semicircular gauge with green, yellow, red zones indicating, respectively, low risk, medium risk, and high risk, such as the gauge 251 illustrated in FIG. 7. For example, a risk score of 0-33 can be displayed as a low risk, green gauge. A risk score of 34-66 can be displayed as a medium risk, yellow gauge. A risk score of 67-100 can be displayed as a high risk, red gauge.

With further reference to alarms, in some embodiments, notifications in the form of alarms indicate certain conditions such as out-of-range pipeline temperatures, which could jeopardize the flow of process fluid in the pipeline, other pipeline alarms, pump alarms, heater cable alarms, DTS system alarms, communication alarms, etc. While the controller 142 may individually display each alarm notification for each segment along the pipeline, it can be beneficial to aggregate alarms so that an operator has a cleaner view of what is occurring thermally along the pipeline 102, allowing the operator to more quickly determine what segments of the pipeline 102 may require attention. For example, when multiple alarms are determined along adjacent segments, the controller 142 can create a larger segment showing the extended length of the alarm condition along the pipeline 102.

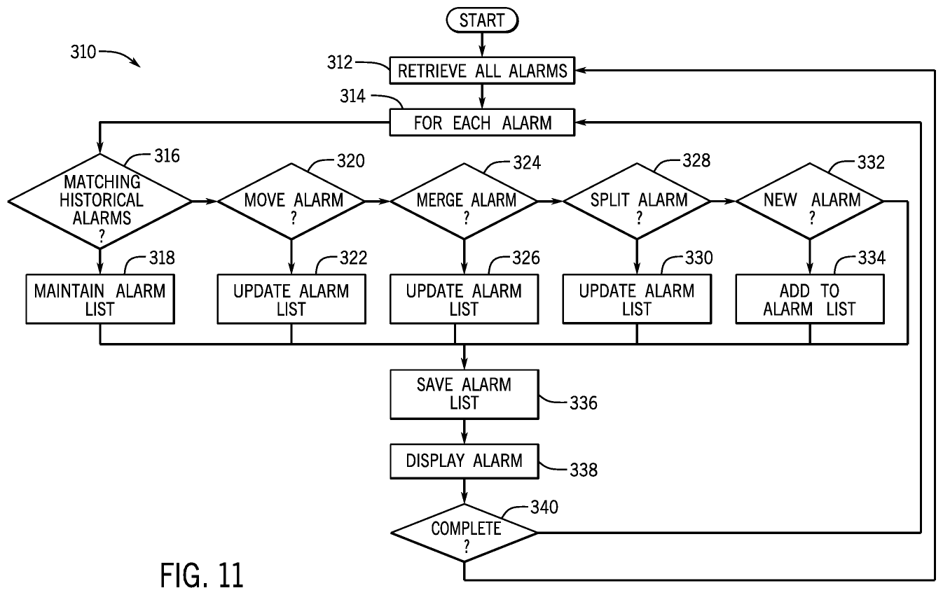

More specifically, FIG. 11 shows an alarm aggregation process 310 according to some embodiments. For example, at step 312, all active alarms can be retrieved by the controller 142. The controller 142 can pull each alarm, at step 314, and determine if it can be matched with an existing historical alarm at step 316. If so, the controller 142 can maintain the historical alarm in an alarm list at step 318. The controller 142 can further determine if the alarm should be moved at step 320, for example, if there is an indication that an extended segment of alarm has shifted, the alarm list can be updated so that an extended alarm segment no longer includes alarms at one end and adds the alarm to the other end (e.g., shifting it over one segment). The controller 142 then updates the alarm list at step 322. The controller 142 can further determine if the alarm should be merged at step 324. For example, if the same alarm is present along adjacent segments, the controller 142 can form an extended segment alarm as a single alarm having a length equal to all adjacent segments. The controller 142 can then update the alarm list with the extended segment alarm at step 326. The controller 142 can further determine if the alarm should be split at step 328. For example, if an extended segment alarm already exists and an alarm is no longer present in one of the segments of the extended segment alarm, the controller 142 can split the extended segment alarm into individual alarms or smaller extended segment alarms that no longer include that particular segment. The controller 142 can then update the alarm list at step 330. Finally, if the controller 142 determines that the alarm does not match a historical alarm (at step 316), should not be moved (at step 320), should not be merged (at step 324), or should not be split (at step 328), the controller 142 can determine that a new alarm exists at step 332. The controller 142 can add the new alarm to the alarm list at step 334. Follow steps 318, 322, 326, 330, and/or 334, the controller 142 can save the alarm list at step 336, display notifications in the form of the alarms (e.g., individual alarms and/or extended segment alarms) at step 338. If all alarms that were retrieved have been analyzed, as determined at step 340, then the controller 142 reverts back to step 312 to again retrieve alarms and repeat the process 310.

Additionally, in some embodiments, the controller 142 can output a notification in the form of a shift report. For example, a shift report can be a summary report for a predetermined time increment (e.g., a past shift interval), in which historical data is summarized, such as high/low temperature values, locations, times, etc. This can be beneficial for operators to obtain key operating data for a specific period in a short summary without having to study historical temperature profiles and other concurrent data. A past shift interval may be a prior time increment between, for example, 5 and 24 hours, such as 5 hours, 10 hours, 12 hours, 18 hours, 24 hours, or another appropriate interval. For example, in order to optimally manage the operation of the system 100, a smooth and seamless handover of key information to an oncoming shift of operating personnel can be beneficial. That is, understanding what has occurred in the last shift can be especially helpful to the shift personnel about to inherit management of the pipeline 102. Furthermore, any unusual conditions or areas of concern can be provided so as to alert the new personnel to a higher level of vigilance. As sifting through information from a past shift can require significant efforts, a shift report can save operators hours of time.

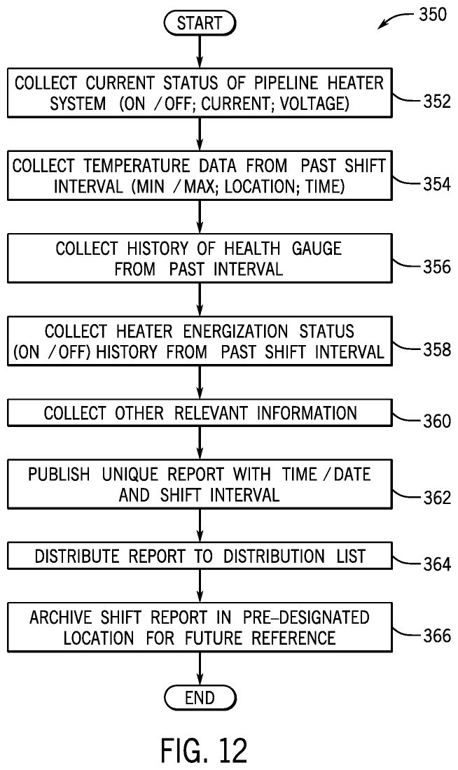

Accordingly, FIG. 12 illustrates a process 350 for providing a shift report according to some embodiments. At step 352, the controller 142 can collect a current status of heating system variables such as, but not limited to, on/off status, current, voltage. At step 354, the controller 142 can collect temperature data from the previous shift interval such as, but not limited to, minimum and maximum temperatures with corresponding locations and times. At step 354, the controller 142 can collect health gauge history (as described above) from the past shift interval. At step 358, the controller 142 can collect heater energization status history from the past shift interval such as, but not limited to, on/off status. At step 360, the controller 142 can collect any other relevant information. At step 362, the controller 142 can generate a report with the time, date, and shift interval. At step 364, the controller 142 can distribute the report, e.g., to a display of the management system 108 and/or to certain remote devices 144. For example, the controller 142 can distribute the report to remote devices 144 based on a stored distribution list of recipients. At step 366, the controller 142 can archive the shift report in a pre-designated location for future reference.

Accordingly, notifications can be in the form of status displays providing information. Some notifications can instruct an operation to take certain actions. For example, the controller 142 can display a notification indicating that wet insulation at a location needs to be repaired or replaced. Such notifications allow for maximizing the efficiency of the thermal envelope around the pipe network to reduce areas of heat loss. As another example, the controller 142 can display a pipeline anchor alert (e.g., based on temperature patterns, as described above, and/or time-to-freeze values), in which a pipeline anchor may need to be serviced.

According to another example, notifications can be in the form of indicating partial or full re-melt procedures in response to detecting solidified process fluid in the pipeline. A challenge in a re-melt is to allow the process fluid 114 (e.g., Sulphur) to move unimpeded throughout the pipeline 102 as it expands through the phase change, and to find those void spaces that were created during freezing (from shrinking Sulphur). The reclaiming of the void spaces with melted Sulphur can prevent significant internal pipe pressure building from occurring. As there are generally insufficient pressure indicators along a pipeline to identify this building pressure, temperature can be the mechanism to monitor and manage pressure build-up.

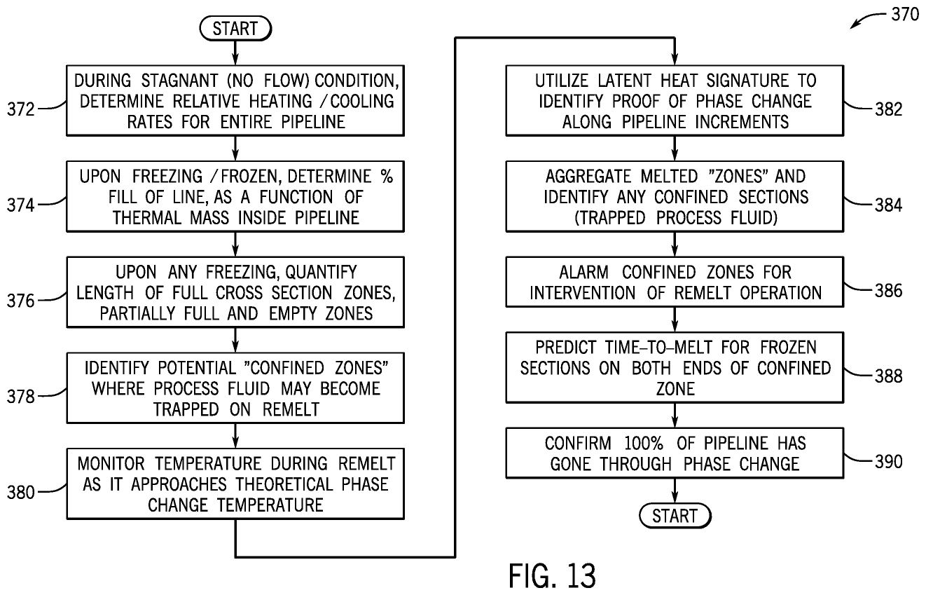

For example, FIG. 13 illustrates an example Sulphur re-melt assistance process 370 according to some embodiments. As shown in FIG. 13, at step 372, during stagnant (no flow) conditions, the controller 142 can determine heating/cooling rates for the entire pipeline 102. At step 374, upon freezing, the controller 142 can determine a percent fill of the pipeline 102, e.g., as a function of thermal mass inside the pipeline 102. At step 376, upon any freezing, the controller 142 can quantify a length of fully plugged zones, partially plugged zones, and/or empty zones. For example, when the solidified Sulphur is localized within a few meter span of pipeline 102, it can be re-melted by use of a partial re-melt routine which temporarily maximizes heater power (and, thereby, corresponding heat output) in the affected area. In this case, the operator can instruct a heating zone which contains the frozen Sulphur and identify the exact location of the plug so that the plug site can be visually inspected and externally heated if necessary. All unaffected heating zones can be set to cycle normally at their stagnant line set point temperature. When the algorithms detect that Sulphur has solidified over longer sections of the pipeline (e.g., greater than a predetermined length), the operator can shift into full re-melt mode in which the entire heating system is energized to achieve melting.

At step 378, the controller 142 can identify potential “confined zones” where Sulphur may become trapped on re-melt. At step 380, the controller 142 can monitor temperature during re-melt as it approaches the theoretical phase change temperature. At step 382, the controller 142 can utilize a latent heat signature to identify phase changes, as described above. At step 384, the controller 142 can aggregate melted “zones” and identify any confined zones sections of trapped Sulphur. At step 386, the controller 142 can display an alarm indicating confined zones for intervention. At step 388, the controller 142 can predict (and/or display) time-to-melt for frozen sections on both ends of a confined zone. For example, the alarms and/or the times can be displayed via a GUI 250, 252 (e.g., such as on one of the pipeline models 256, 258 in the GUI 252 of FIG. 8). At step 390, the controller 142 can confirm that the entire pipeline 102 has going through solid-to-liquid phase change. For example, the operator can then return the activated heating zone to normal operation once thermal evidence (e.g., DTS data) has been collected by the controller 142 verifying that the plug re-melt has been fully completed.

In some embodiments, the system 100 may take required actions automatically, without user intervention. For example, when it is determined that process fluid 114 is beginning to solidify or has solidified, the controller 142 can automatically execute a re-melt process by instructing specific heat tubes 154 to provide additional heat (e.g., beyond that which is needed to maintain the temperature of pipeline 102 at a setpoint temperature) to sections of pipe 112 in which solidification of process fluid is detected to be occurring. This may be considered a closed-loop re-melt approach.

In further embodiments, the system 100 may incorporate a partial or fully closed-loop approach, in which the controller 142 can establish optimum temperature setpoints for the heating system 104 based on the DTS data and data from the heating system 104. Such optimum setpoints can be indicated to an operator via a notification, as described above, or can be used by the controller 142 to directly control the heating system 104 based on real-time temperature values.

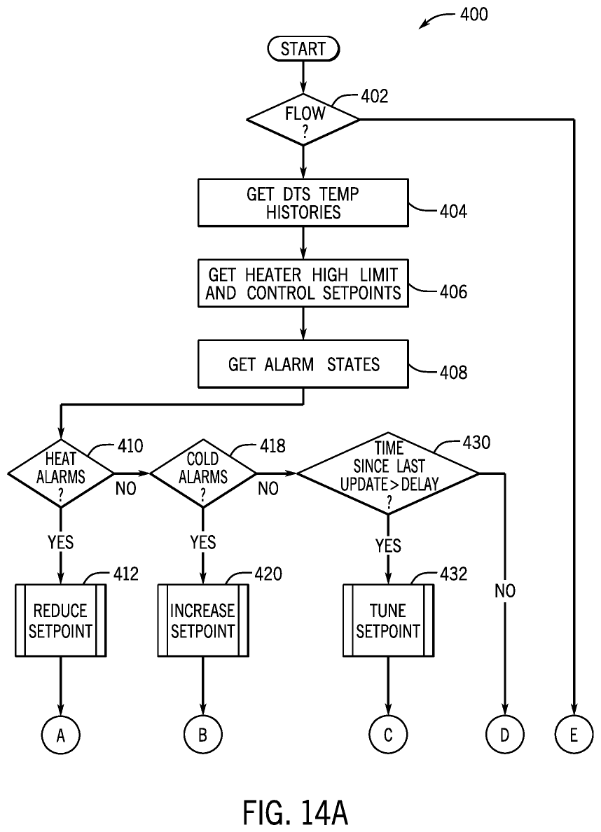

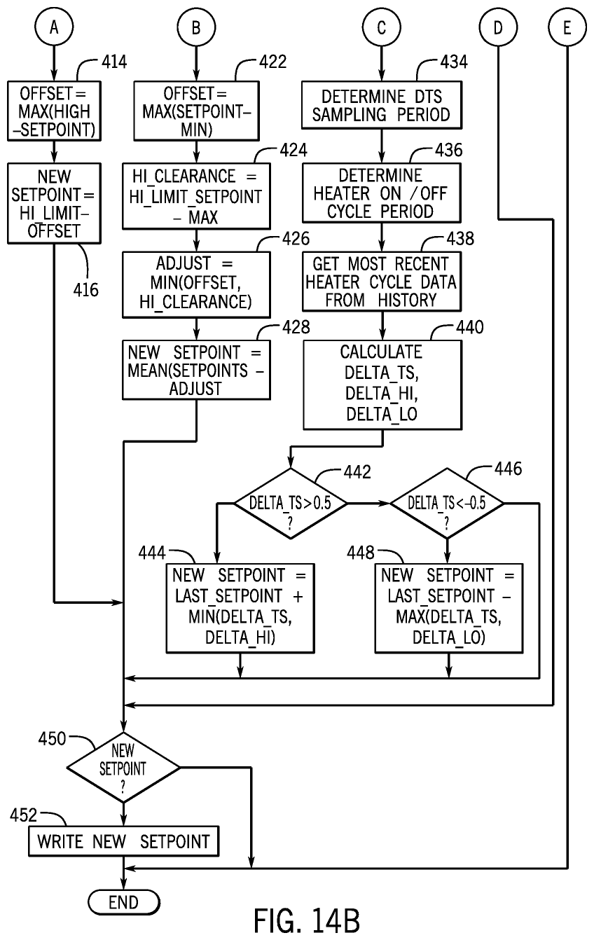

For example, FIGS. 14A and 14B illustrate a control process 400 according to some embodiments, As shown in FIGS. 14A and 14B, at step 402, the controller 142 can determine whether there is flow through the pipeline 102. If not, the controller 142 can retrieve DTS temperature histories at step 404. In some embodiments, the controller 142 can use one or more temperature values from along the pipeline 102. In other embodiments, the controller 142 can use all of the DTS temperatures, in order to assure that the entire pipeline 102 is kept between upper and lower temperature limits.

At step 406, the controller 142 can retrieve heating system high limits and control setpoints (e.g., from the controller 140). At step 408, the controller 142 can retrieve all alarm states. At step 410, the controller 142 determines if any alarm states indicate hot alarms. If so, the controller 142 reduces a temperature setpoint at step 412. That is, as shown in FIG. 14B, at step 414, the controller 142 determines an offset by calculating a maximum value of the highest temperature found plus the retrieved control setpoint. At step 416, the controller 142 creates a new setpoint based on the offset, e.g., by subtracting the offset from the high temperature limit.

Referring back to FIG. 14A, if no hot alarms are indicated, the controller 142 determines if any alarm states indicate cold alarms at step 418. If so, the controller 142 increases a temperature setpoint at step 420. That is, at shown in FIG. 14B, at step 422, the controller 142 determines an offset by calculating a maximum of the retrieved setpoint minus the lowest temperature found. At step 424, the controller 142 determines a high clearance as a retrieved hot heating temperature high limit minus the maximum temperature found. At step 426, the controller 142 determines an adjustment factor as the less of the offset and the high clearance. At step 428, the controller 142 creates a new setpoint as a mean of all setpoints along the pipeline minus the adjustment factor.

Additionally, referring back to FIG. 14A, if no hot or cold alarms are indicated, the controller 142 compare a time since the last setpoint update to a stored delay interval at step 430. For example, the controller 142 can incorporate fast-cycling protection, to ensure that that heating system controls do not cycle off and on too quickly. This may be helpful for longer pipeline heating systems that are very high load (e.g., in the hundreds to thousands of kilowatts per heating circuit). Thus, if the controller 142 determines a time since a last update was made is greater than a predetermined control delay at step 430, the controller 142 tunes the temperature setpoint at step 432. That is, as shown in FIG. 14B, at step 434, the controller determines a DTS sampling period. At step 436, the controller 142 determines a heating system on/off cycle period (e.g., from retrieved temperature histories). At step 438, the controller 142 retrieves a most recent heater cycle data from history. At step 440, the controller 142 calculates a delta setpoint temperature (“delta_ts”), a delta high limit (“delta_hi”), and a delta low limit (“delta_low”). The delta setpoint temperature can be calculated as a target setpoint temperature (e.g., a stored ideal temperature, such as input by an operator) minus a mean of the pipeline temperatures. The delta high limit can be calculated as the high limit setpoint minus a maximum temperature along the pipeline. The delta_low limit can be calculated as a minimum temperature along the pipeline minus a low limit setpoint.

At step 442, the controller 142 determines if detal_ts is greater than a first stored threshold (e.g., 0.5). If so, at step 444, the controller 142 sets a new setpoint as the last setpoint plus the lesser of delta_ts and delta_hi. If not, the controller 142 determines if delta_ts is less than a second stored threshold (e.g., −0.5) at step 446. If so, the controller 142 sets a new setpoint as the last setpoint plus the higher of delta_ts and delta_lo.

Following steps 416, 428, 444, or 448, the controller 142 determines if there is a new setpoint at step 450. If so, the controller 142 then stores the new setpoint at step 452. For example, the new setpoint may be displayed as a notification in some embodiments. In other embodiments, the new setpoint may be communicated to the heating system 104 for automatic heating system control.

In light of the above, an “intelligent” pipeline as provided herein seeks to maintain a uniform thermal profile along the pipeline, even in plugged and re-melt situations. To achieve a homogenous thermal profile for the entire pipeline, the systems of some embodiments can integrate existing pipeline heating technology, pre-insulated piping, a sensor network (e.g., a fiber optic based Distributed Temperature Sensing (DTS) system) to monitor pipeline temperature along the entire length of the pipeline, engineered pipe supports and anchors that minimize localized heat loss, and computational modelling and transient analysis. Together, all of these system components and customized procedures can create synergies in the operation of process fluid transport pipelines.

Accordingly, using the systems and methods described herein, automated or assisted re-melt may be performed based on DTS data for the pipeline and other dynamic information gathered for the pipeline. As such, re-melt processes may become more predictable, with less left to chance. Furthermore, the data processing associated with methods of some embodiments extends beyond traditional pipeline temperature monitoring, which is generally limited to providing pre-alarms or alarms when the pipeline temperature has moved out of the acceptable range for some portion of the pipeline. Instead, the systems and methods of some embodiments provide data analysis modules that can be used in the support of the day-to-day operation and maintenance of the pipeline.

It should be noted that the controllers described herein comprise a processor and memory storing specific computer-executable instructions that, when executed by the processor, carry out the steps of any of the methods described above. Furthermore, while the methods herein are shown and described as steps in a particular order, in some embodiments, certain steps may be eliminated, added, or rearranged in a different order.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected. For example, any of the features or functions of any of the embodiments disclosed herein may be incorporated into any of the other embodiments disclosed herein. Various features and advantages of the invention are set forth in the following claims.

1. A control system for use with a pipeline that transports a process fluid, the control system comprising:
a distributed temperature sensing system that records temperature data at a plurality of segments along the pipeline;
a heating system that heats the process fluid in the pipeline; and
a management system including a controller in electronic communication with the distributed temperature sensing system and the heating system, the controller comprising a processor and memory storing specific computer-executable instructions that, when executed by the processor, cause the controller to:
receive the temperature data from the distributed temperature sensing system;
determine a first alarm condition for each segment of the plurality of segments along the pipeline;
when the first alarm condition is present in adjacent segments, merge the first alarm condition to create an extended segment first alarm condition encompassing the adjacent segments; and
display, via a graphical user interface, a representation of the extended segment first alarm condition.

2. The control system of claim 1 and further comprising updating an alarm list to include the extended segment first alarm condition.

3. The control system of claim 2 and further comprising, when a second alarm condition matches a historical alarm condition already saved in the alarm list, maintaining the historical alarm condition in the alarm list.

4. The control system of claim 2 and further comprising when a third alarm condition does not match a historical alarm condition already saved in the alarm list, adding the third alarm condition to the alarm list.

5. The control system of claim 1, further comprising when the first alarm condition is no longer present in one of the adjacent segments, splitting the extended segment first alarm condition.

6. The control system of claim 1, further comprising shifting the extended segment first alarm condition to include additional segments.

7. The control system of claim 1, wherein the first alarm condition includes one of an out-of-range pipeline temperature condition, a pipeline alarm, a pump alarm, a heating system alarm, a temperature sensing system alarm, and a communication alarm.

8. A control system for use with a pipeline that transports a process fluid, the control system comprising:
a distributed temperature sensing system that records temperature data at a plurality of segments along the pipeline, wherein the plurality of segments make up a total length of the pipeline;
a heating system that heats the process fluid in the pipeline; and
a management system including a controller in electronic communication with the distributed temperature sensing system and the heating system, the controller comprising a processor and memory storing specific computer-executable instructions that, when executed by the processor, cause the controller to:
receive the temperature data from the distributed temperature sensing system;
determine a first condition for each segment of the plurality of segments along the pipeline;
calculate a risk score of the pipeline based on the first alarm condition; and
display, via a graphical user interface, a representation of the risk score.

9. The control system of claim 8, wherein calculating the risk score includes:
calculating an alarm fraction for the first alarm condition, the alarm fraction equating to a number of segments in which the first alarm condition is present over the total length of the pipeline; and
when the alarm fraction is greater than a limit, adding a stored first alarm condition risk value to the risk score.

10. The control system of claim 9, wherein calculating the risk score further includes:
calculating a second alarm fraction for a second alarm condition, the second alarm fraction equating to a number of segments in which the second alarm condition is present over the total length of the pipeline; and
when the second alarm fraction is greater than a second limit, adding a stored second alarm condition risk value to the risk score.

11. The control system of claim 9, wherein calculating the risk score further includes:
when the alarm fraction is less than the limit, not adding to the risk score.

12. The control system of claim 9, wherein the representation of the risk score includes a numerical value.

13. The control system of claim 12, wherein the representation of the risk score includes an image of a colored gauge including a color based on the risk score.

14. The control system of claim 8, wherein the first condition includes one of an out-of-range pipeline temperature condition, a pipeline alarm, a pump alarm, a heating system alarm, a temperature sensing system alarm, and a communication alarm.

15. A control system for use with a pipeline that transports a process fluid, the control system comprising:
a distributed temperature sensing system that records temperature data at a plurality of segments along the pipeline;
a heating system that heats the process fluid in the pipeline; and
a management system including a controller in electronic communication with the distributed temperature sensing system and the heating system, the controller comprising a processor and memory storing specific computer-executable instructions that, when executed by the processor, cause the controller to:
receive the temperature data from the distributed temperature sensing system;
map the plurality of segments to a virtual model of the pipeline by coordinating temperature data associated with ends of the distributed temperature sensing system to ends of the pipeline;
determine a condition of each segment of the plurality of segments along the pipeline; and
display, via a graphical user interface, the condition on the virtual model of the pipeline.

16. The control system of claim 15, wherein the condition includes temperature.

17. The control system of claim 15, wherein the condition includes an alarm condition.

18. The control system of claim 15, wherein the condition includes a percentage of pipe diameter in the segment that filled with solid process fluid.
